(19) United States
(12) Patent Application Publication
(10) Pub. No.: US 2010/0280712 A1
(43) Pub. Date: Nov. 4, 2010

(54) Hybrid Vehicles and Control Methods

(76) Inventor: Timothy James Bowman, Bexley (GB)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 12/772,427

(22) Filed: May 3, 2010

(30) Foreign Application Priority Data
May 1, 2009 (GB) 0907525.0

(51) Int. Cl. G06F 19/00; B60K 6/10

(52) U.S. Cl. 701/36; 180/165

(57) ABSTRACT

A hybrid vehicle 1 incorporates a drivetrain having a flywheel-based energy storage and recovery system 10 which can drive or be driven by the input shaft 4 of an automatic manual shift gearbox 5. The arrangement minimises vehicle driveline lash and provides a large number of operating modes.

This invention relates to hybrid vehicles and methods for controlling such vehicles. In particular, the invention relates to hybrid vehicles having a prime mover and an energy storage and recovery system.

One known example of an energy storage and recovery system incorporates a flywheel.

SAE technical paper 2008-01-0083, Apr. 14-17, 2008, describes an arrangement consisting of a continuously variable transmission (CVT) connected between the engine and gearbox of a vehicle and configured to drive a flywheel through a gearset. The arrangement can add or subtract power to that supplied by the engine.

In a flywheel-based energy storage and recovery system, manipulation of the CVT ratio achieves control of energy storage and recovery. When the ratio is set so as to speed up the flywheel, energy is stored and when the ratio is set so as to slow down the flywheel, energy is recovered.

It is an object of the invention to provide an improved drivetrain for a hybrid vehicle.

According to a first aspect of the invention there is provided a drivetrain for a hybrid vehicle comprising a prime mover, an energy storage and recovery system and a gearbox wherein the energy storage and recovery system is a high speed flywheel, the gearbox has an input shaft and an output shaft driveably connected to the input shaft to provide a number of drive ratios and operable to provide drive to at least one road wheel, one end of the input shaft is connectable with the prime mover via a first clutch and a distal end of the input shaft is connectable with the flywheel via a second clutch.

The drivetrain may further comprise a continuously variable transmission located between the flywheel and the second clutch.

The drivetrain may further comprises a reduction gearbox between the continuously variable gearbox and the flywheel.

The drivetrain may further comprise a controller to control the operation of the prime mover, the first and second clutches and the power flow to and from the flywheel.

The controller may be arranged to receive at least one input indicative of a driver demand and control the operation of the prime mover, the first and second clutches and the power flow to and from the flywheel based upon at least one of the current state of charge of the flywheel, the current operating state of the prime mover and a current driver demand in order to satisfy a current operating need.

The gearbox may be an automated manual gearbox.

The drivetrain may further comprises a hydraulic machine driveably connected to the output shaft and hydraulic accumulator connected to the hydraulic machine wherein the hydraulic machine is driven by the output shaft during normal running of the drivetrain to charge the hydraulic accumulator and the hydraulic machine is arranged to receive hydraulic fluid from the hydraulic accumulator during a gear change operation of the gearbox so as to maintain the flow of power to the at least one driven wheel during the gear change.

The hydraulic machine may be an oil pump and the oil pump may be arranged to supply pressurised oil to a continuously variable gearbox, said oil pump being connected to the output shaft of the gearbox.

The drivetrain may further comprise an electric machine driveably connected to the input shaft and battery operatively connected to the electric machine wherein the electric machine is arranged to be driven by the input shaft in order to charge the battery.

The first clutch may be open, the second clutch may be closed, the gearbox may be in neutral and the input shaft may be driven by the flywheel to recharge the battery.

When required, the electric machine may be arranged to drive the input shaft using power stored in the battery.

The electric machine and the flywheel may be used in combination to drive the input shaft.

The first clutch may be open, the second clutch may be closed and the gearbox may be in neutral and the electric machine may be used to recharge the flywheel.

The first and second clutches may be both closed and the prime mover and the flywheel may be both used to drive the input shaft to drive the hybrid vehicle.

Preferably, the prime mover may be an internal combustion engine.

Alternatively, the prime mover may be an electric traction motor.

The drivetrain may include a starter motor for starting the engine and the starter motor may be selectively used to recharge the flywheel.

The drivetrain may further include at least one accessory connectable to the distal end of said input shaft.

According to a second aspect of the invention there is provided a hybrid vehicle having a drivetrain constructed in accordance with said first aspect of the invention.

According to a third aspect of the invention there is provided a method of operating a hybrid vehicle in which the vehicle includes a drivetrain comprising a gearbox, a prime mover, connectable with one end of an input shaft of the gearbox via a first clutch, an energy storage and recovery device in the form of a high speed flywheel connectable with a distal end of said input shaft via a second clutch and an output shaft driveably connected to the input shaft to provide a number of drive ratios and operable to provide drive to at least one road wheel, the method comprising operating the drivetrain in one of a number of predefined operating modes in order to satisfy a current operating need, wherein the current operating need is based upon at least one of a state of charge of the flywheel, the operating state of the prime mover and a driver demand.

The method may further comprise prioritising the operating needs and selecting an operating mode to satisfy the need accorded the highest priority.

The method may further comprise detecting a vehicle deceleration demand establishing an operational need to charge the flywheel and, in response thereto, opening the first clutch and closing the second clutch whereby energy is transferred from the vehicle to the flywheel.

The method may comprise establishing an operational need for prime mover power and operating the drivetrain in a power switch mode in which, while the first clutch is open, increasing engine speed until it substantially matches the rotational speed of the input shaft, then closing the first clutch and opening the second clutch.

The method may comprise establishing a need for vehicle acceleration, determining if the demand can be met solely by release of energy stored in the flywheel and, if so, selecting a low emission mode in which the second clutch is engaged, transferring energy from the flywheel to the input shaft and selecting a high gear in the gearbox.

The method may comprise establishing a need for vehicle acceleration, determining if the demand can be met solely by release of energy stored in the flywheel and, if not, selecting a high power mode in which the second clutch is engaged and energy is transferred from the flywheel to the input shaft, selecting a low gear in the gearbox and increasing the power output of the prime mover.

The prime mover may be an internal combustion engine and the method may comprise establishing a need for starting the internal combustion engine and selecting a flywheel start mode comprising the steps of selecting neutral in the gearbox, closing the first clutch and closing the second clutch whereby energy stored in the flywheel is used to crank the engine.

The method may comprise the steps of establishing an operational need to charge the flywheel and selecting a flywheel charge mode comprising starting the prime mover, selecting neutral in the gearbox, closing the first clutch and closing the second clutch whereby energy from the prime mover is transferred to the energy storage and recovery device.

The drivetrain may further comprise a generator driven by the input shaft and a battery connected to the generator and the method may comprise establishing a need to charge the battery and operating the drivetrain in a battery charging mode by disabling the prime mover, disengaging the first clutch, closing the second clutch and selecting a gear other than neutral in the gearbox, whereby the vehicle is powered by the energy storage and recovery device alone and the generator is driven by the energy storage and recovery device thereby charging the battery.

The current operating need may be based upon at least one of a state of charge of the battery, a state of charge of the flywheel, the operating state of the prime mover and a driver demand.

The drivetrain may further comprise a hydraulic machine driveably connected to the output shaft of the gearbox, a hydraulic accumulator connected to the pump and the method may comprise establishing an operational need for a gear change and operating the drivetrain in a gearshift fill-in mode by causing the hydraulic machine to apply torque to the output shaft during gear shifts.

The current operating need may be based upon at least one of a state of charge of the hydraulic accumulator, a state of charge of the flywheel, the operating state of the prime mover and a driver demand.

The gearbox may be an automated manual gearbox.

The prime mover may be an internal combustion engine, the drivetrain may further comprise a starter motor for the engine and the method may comprise establishing a current operational need for flywheel charging and operating the drivetrain in a flywheel charging mode by opening the first clutch, selecting neutral in the gearbox, engaging the second clutch, instructing the starter motor to crank the input shaft thereby transferring energy to the energy storage and recovery system.

The prime mover may be an internal combustion engine, the drivetrain may further comprise a starter motor for the engine and the method may comprise establishing a current operational need for flywheel charging and operating the drivetrain in a starter charge mode by closing the first and second clutches, selecting neutral in the gearbox, inhibiting fuel flow to the engine, cranking the engine with the starter motor whereby energy is transferred from the starter motor to the energy storage and recovery system through the gearbox.

The drivetrain may further comprise a generator connectable with the distal end of said input shaft and the method may comprise establishing a need for generator driving and selecting a low emission generator drive mode by disabling the prime mover, opening the first clutch, selecting neutral in the gearbox, and closing the second clutch whereby energy from the flywheel is transferred to the generator.

The drivetrain may further comprise a generator connectable with the distal end of said input shaft and a battery connected to the generator and the method may comprise establishing a need for zero emission cruising and selecting a zero emission drive mode in which the generator and the flywheel are used in combination to drive the input shaft.

Some embodiments of the invention will now be described, by way of example only, with reference to the drawings of which;

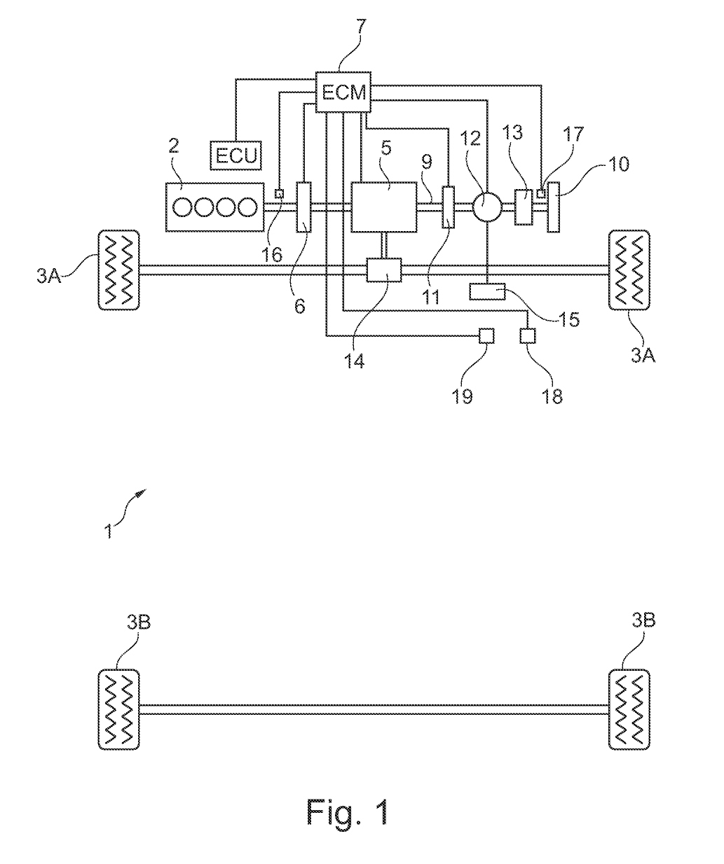

FIG. 1 is a schematic block diagram of a vehicle in accordance with an embodiment of the invention,

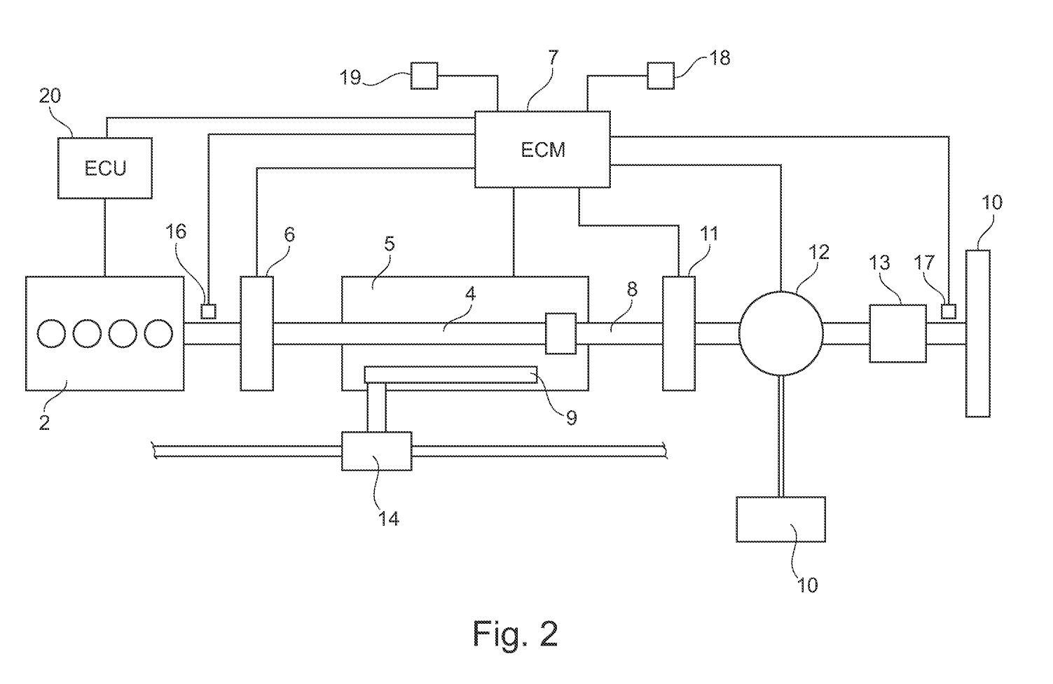

FIG. 2 is a schematic block diagram showing a part of FIG. 1 in greater detail.

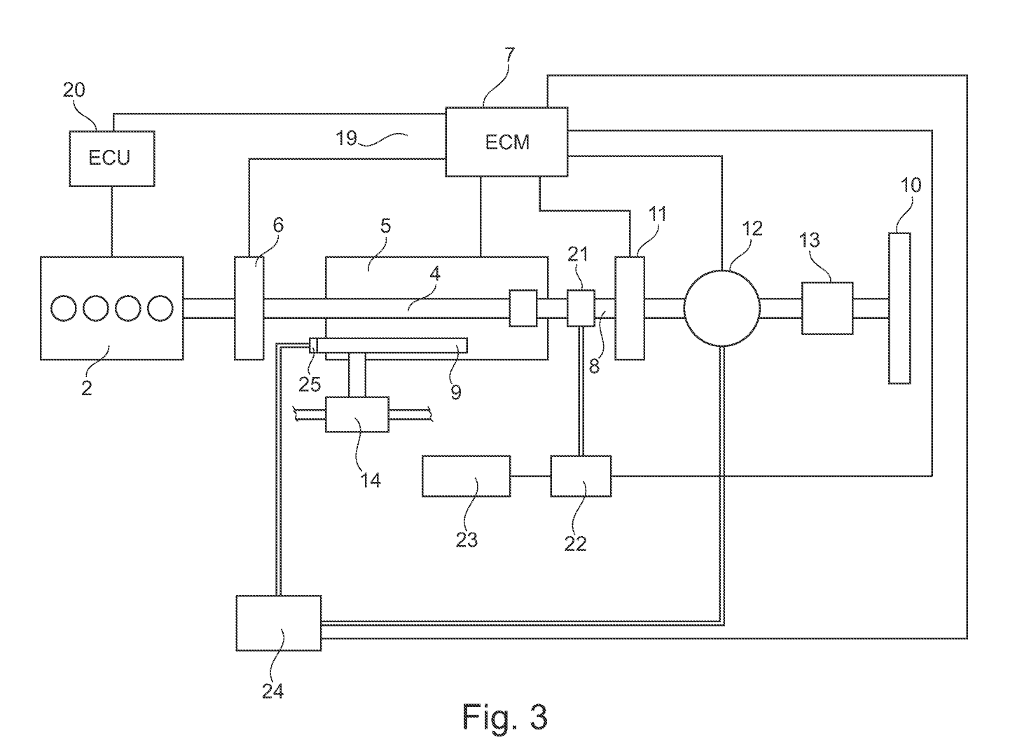

FIG. 3 is a schematic block diagram of an alternative arrangement in accordance with a second embodiment

With reference to FIGS. 1 and 2 a vehicle 1 has a 4-cylinder internal combustion engine 2 and first and second pairs of wheels 3A, 3B. In this example, the engine 2 is arranged to drive just one pair of wheels, 3A.

The engine 2 is connected to one end of an input shaft 4 of an automatic shifting manual gearbox 5 via an electro-hydraulic clutch 6. Both the gearbox 5 and clutch 6 are controlled by an electronic control module (ECM) 7. The other end of the input shaft 4 is connected to a driveline 8. The input shaft 4 is connectable to an output shaft 9 of the gearbox via a gear set (not shown) so as to provide a number of drive ratios therebetween. The driveline 8 can drive and be driven by a high speed flywheel 10 via a second electro-hydraulic clutch 11, a continuously variable transmission 12 and a reduction gear 13. A final drive unit 14 is connected between the output shaft 9 of the gearbox 5 and the first pair of wheels 3A.

In one exemplary embodiment the flywheel 10 has a maximum operational rotational speed of 60,000 RPM. It will be appreciated that the term high speed flywheel as meant herein means a flywheel that has a maximum operational speed several times faster than the maximum rotational speed of the engine 2 in order to minimise the size of the flywheel 10 while providing a significant magnitude of stored energy. The term state of charge (SOC) as meant herein with respect to the flywheel means the amount of energy stored in the flywheel 10. When the flywheel 10 is stationary it has an SOC of 0% and when the flywheel 10 is rotating at its maximum operational speed it has an SOC of 100%.

In one exemplary embodiment the reduction gear has a ratio of 8.31 to 1. That is to say the flywheel 10 rotates 8.31 times faster than the shaft entering the CVT 12.

An electrically operated oil pump 15 supplies pressurised oil to the CVT 12. The CVT 12 and second clutch 11 are also under the control of the ECM 7. The ECM 7 receives input signals from an engine speed sensor 16, a flywheel speed sensor 17, an accelerator pedal position sensor 18 and a brake pedal position sensor 19,

The first and second clutches 6 and 11 are controlled by the ECM 7 to provide at least an open or disengaged state and a closed or engaged state.

The ECM 7 is arranged to control the operation of the engine via an ECU 20, the gearbox 5, the first and second clutches 6 and 11, the CVT 12 and the power flow into and out of the flywheel 10 to provide one of a number of predefined operating modes in order to satisfy a current operational need. The ECM 7 receives various inputs of driver demand from sensors such as the brake and accelerator sensors 19 and 18 along with inputs indicative of current operating conditions such as for example engine speed from speed sensor 16 flywheel speed from speed sensor 17 and vehicle speed from a vehicle speed sensor (not shown) and uses these to determine a current operational need of the vehicle.

In one embodiment of the ECM 7 it includes priority based logic to determine which operating mode to select based upon a number of inputs when the operational need can be met by more than one operational mode.

That is to say the ECM 7 is arranged to prioritise the operating needs and select an operating mode to satisfy the need accorded the highest priority. It will be appreciated that there may be several operating modes that will satisfy a need and the ECM 7 chooses the one best suited to meet the current need.

Whenever a forward gear is selected in the gearbox 5 and the second clutch 11 is closed, rotational energy can be transferred between the wheels 3A and the flywheel 10.

In addition, when both of the clutches 6 and 11 are closed, rotational energy can be transferred between the engine 2 and the flywheel 10.

The CVT 12 is of conventional design, and its ratio is varied in a known manner by operation of solenoid valves (not shown) which control the oil flow from the pump 15. Activation of the valves is under the control of the ECM 7. In one exemplary embodiment the CVT 12 has a ratio range of 2.52 to 1 to 0.42 to 1.

The engine control unit (ECU) 20 controls the power output of the engine 2 and receives signals from the ECM 7 and accelerator pedal position sensor 18.

Several modes and operational needs of the hybrid vehicle will now be described in greater detail.

Initially, the vehicle 1 is cruising under power supplied by the engine 2 only, with the second clutch 11 open and a gear other than neutral selected. The flywheel speed (as monitored by the speed sensor 17) is zero.

The driver then makes a deceleration demand either by solely lifting his foot off the accelerator pedal or by lifting off and depressing the brake pedal. Signals from the accelerator pedal position sensor 18 and brake pedal position sensor 19 inform the ECM 7 of this demand. In response, the ECM 7 checks the SOC of the flywheel 10 and will find that the SOC is 0%. This indicates an operational need to recharge the flywheel 10 because if it is possible the flywheel 10 is kept in a high state of charge. The ECM 7 then operates the drivetrain in an energy recouperation mode and opens the clutch 6 between engine 2 and gearbox 5, closes the second clutch 11 and sets the CVT ratio so that energy can be transferred from the rotating wheels 3A to the flywheel 10 through the CVT output shaft 9, input shaft 4 and driveline 8.

Hence the flywheel 10 spins up increasing its SOC, taking kinetic energy from the vehicle and causing the vehicle 1 to decelerate. Opening the clutch 6 has the advantage that it leads to a reduction in parasitic losses that would tend to decelerate the vehicle. Therefore more energy can be transferred to and stored in the flywheel 10 during this manoeuvre.

When the driver takes his foot off the brake pedal, this action is signalled to the ECM 7 by the brake pedal position sensor 19. In response, the ECM 7 re-engages the clutch 6 and opens the second clutch 11 so that the hybrid vehicle is driven in a normal power mode. The amount of energy stored in the flywheel 10 at this point is a function of its speed (as monitored by the speed sensor 17) and can be calculated by the ECM 7 to determine its new SOC.

The process of storing energy in an energy storage device during a deceleration manoeuvre is known as regenerative braking. The energy storage device, i.e. the flywheel 10 in this example, captures energy that would otherwise be dissipated as heat generated in the braking components by friction.

The ECM 7 now determines whether the vehicle can now cruise on flywheel power only. If it is determined that the energy recouperated from the regenerative braking has increased the SOC of the flywheel to a sufficient level to permit the flywheel alone to power the hybrid vehicle and an operational need still exist for vehicle drive then the ECM 7 selects a low emission drive mode. In this low emission drive mode of operation, the ECM 7 disengages the clutch 6, closes the second clutch 11, sets an appropriate CVT ratio and selects an appropriate gear in the gearbox 5. The engine 2 now rotates at idling speed while the flywheel 10 alone drives the wheels through the gearbox 5.

When the ECM 7 detects by monitoring flywheel speed that the flywheel 10 has expended its energy (SOC=0%), it instructs the ECU 20 to increase idle speed to match the rotational speed of the input shaft 4 and then re-engages the clutch 6 so as to reengage the normal drive mode of operation. It also disconnects the second clutch 11 so that the wheels 3A can be driven solely by the engine. Speeding up the engine to match the gearbox's input shaft speed before re-engaging the clutch 6 ensures a smooth transition from flywheel driving torque to engine driving torque. The speed of the input shaft can be calculated (in the ECM 7) knowing the flywheel speed, reduction gear ratio and CVT ratio.

If in a subsequent manoeuvre the driver makes an acceleration demand by pressing on the accelerator pedal indicating a current operational need for vehicle acceleration, this demand and its magnitude are detected by the accelerator pedal position sensor 18 and relayed to the ECM 7. In response, the ECM 7 determines what proportion of the acceleration demand can be met by release of the energy stored in the flywheel 10 and how much needs to be supplemented by an increase in engine output.

If the demand is relatively low and can be met by release of flywheel energy alone, then the ECM 7 selects a low emission mode of acceleration in which it engages the second clutch 11 and sets the CVT ratio so that energy can be transferred from the flywheel 10 to the wheels 3A via the driveline 8 and output shaft 9. No increase in engine power is requested of the ECU 20 and a high gear is selected in the gearbox 5.

If the acceleration demand is relatively high and the ECM 7 calculates that both flywheel power and increased engine power are required to meet the demand, it selects a high power mode of acceleration and requests the ECU 20 to adjust engine power output accordingly. The ECM 7 also (as before) closes the clutch 11 and sets the CVT 12 to the appropriate ratio however in this case it also instructs the gearbox 5 to select a lower gear.

Hence in both these acceleration manoeuvres the flywheel 10 and the engine 2 together supply a driving torque to the input shaft 4, thence to the driven wheels 3A via the output shaft 9 and final drive 14. Eventually, the flywheel 10 will slow down as its previously stored energy is released and when the SOC of the flywheel 10 falls below a predetermined limit or falls to 0%, the ECM 7 opens the second clutch 11 and the vehicle 1 reverts to being powered by the engine alone in the normal drive mode.

If the engine 2 is not running but there is an operational need for it to be running then a spinning flywheel 10 can be used to crank the engine 2. Hence the embodiment of FIGS. 1 and 2 can be advantageously incorporated in a hybrid vehicle operating a stop/start strategy. For example, if the engine 2 has been switched off in order to conserve fuel while the vehicle is stationary at a junction and the flywheel 10 is rotating with a sufficient SOC then, when it is safe to move off again, the ECM 7 can select a flywheel start mode of operation and the engine 2 can be cranked by selecting neutral in the gearbox 5 and closing both clutches 6 and 11. Using the energy which had been previously stored in the flywheel 10 obviates the necessity of using electrical charge from the vehicle battery to start the engine 2. Thus, once started in this fashion, the engine 2 will not have to provide any power to replenish the battery charge. So there will be a fuel economy benefit.

A further operating strategy which the embodiment of FIGS. 1 and 2 may perform is as follows. This relates to starting the vehicle 1 when the engine 2 is cold and the flywheel speed is zero. The aim of this particular cold start up mode of operation is to pre-charge the flywheel 10 with some rotational energy so that the flywheel 10 can assist the engine 2 in launching the vehicle from rest and increase the speed of engine warm-up.

This capability provides a small-engined hybrid vehicle with motive power equivalent to that provided in a conventional vehicle fitted with a larger engine. The engine 2 is started by conventional means using a battery and starter motor combination (not shown). Neutral is selected in the gearbox 5 by the ECM 7 and both clutches 6 and 11 are closed by the ECM 7.

The ECM 7 instructs the ECU 20 to increase engine idle speed and sets the CVT ratio so that energy can be transferred from the rotating input shaft 4 to the flywheel 10. Alternatively, engine load can be increased by setting the engine throttle (not shown) to its wide open position and selecting an appropriate CVT ratio to enable the flywheel 10 to absorb the surplus engine power.

Hence the engine is used to pre-charge the flywheel 10 to a pre-determined speed/SOC. Engine speed and flywheel speed are monitored by the sensors 16,17 and relayed to the ECM 7. When the flywheel 10 reaches the desired pre-determined speed, the engine speed can be reduced back to normal idle speed (or the throttle closed).

Advantageously, because the engine is loaded while to charging the flywheel i.e. doing more work than it would if it were unconnected to the flywheel, the engine coolant heats up more quickly as does the exhaust after-treatment system. This benefits fuel economy.

When the driver is ready to move off, that is to say, the operational need is for vehicle acceleration, the ECM 7 selects a dual drive mode of operation and controls the clutch 6 and gearbox 5 appropriately and resets the CVT ratio so that the flywheel's energy can be transferred to the wheels 3 (along with additional motive power from the engine 2) via gearbox 5 and final drive 14.

Some further modes of operation will now be described with reference to FIG. 3. Those components common to FIG. 2 and FIG. 3 bear the same reference numerals.

In the alternative arrangement of FIG. 3 a first power take-off device 21 is connected to the driveline 8 to between the gearbox 5 and the second clutch 11. This device 21 is used to drive auxiliary devices such as an alternator, starter-generator, air conditioning compressor.

In FIG. 3 just one auxiliary device, specifically a starter-generator unit 22 is shown for the sake of clarity. The starter-generator unit 22 is electrically connected to the vehicle's battery 23. The generator function of the unit 22 can be driven by the gearbox input shaft 4 which, in turn, may be driven by the engine 2, the flywheel 10 or both.

The starter function of the unit 22 can be used to retrieve stored electrical energy from the battery 23 to crank the engine 2 via the gearbox input shaft 4 (engine start mode) or spin up the flywheel via the driveline 8 (flywheel recharge mode).

In this alternative arrangement instead of employing an electric pump for supplying oil to the CVT 12, a hydraulic assembly is provided instead. This hydraulic assembly has a combined pump and motor 25 driveably connected to the output shaft 9 and a hydraulic accumulator 24. Conveniently, the hydraulic assembly can also provide a pressurised hydraulic supply for actuating the clutch 6 and the gear change and selection mechanisms in the gearbox 5.

Thus the output shaft 9 of the gearbox provides the energy for operating the hydraulic pumping mechanism 25 so as to charge the hydraulic accumulator 24. Conversely, the motor function of the hydraulic assembly 24 can be used to drive the gearbox output shaft 9 by recouperating fluid at pressure from the hydraulic accumulator 24.

The modes of operation which have been described above with reference to FIG. 2 can be implemented by the embodiment of FIG. 3 also. Additionally the embodiment of FIG. 3 can implement the following strategies.

When the vehicle is running under flywheel power alone, the engine 2 can be switched off and the clutch 6 disengaged. As the starter-generator unit 22 is being run off the input shaft 4, which is being driven by the flywheel 10 in this flywheel to battery charge mode, the battery 23 will still be charged, even though the engine 2 is off. When the ECM 7 determines that an operational need exists for the vehicle motive power to be supplemented by the engine 2 a power transfer operational mode is selected and, with the clutch 6 still open, it instructs the ECU 20 to start the engine 2 and increase its speed to match that of the gearbox input shaft 4. When this is done, the ECM 7 closes the clutch 6 and opens the second clutch 11. Motive power is thus smoothly handed over to the engine 2, the engine is now also providing drive to the starter-generator 22.

In a gear shift fill-in mode of operation selected in response to an operational need for a change in ratio of the gearbox 5, the hydraulic assembly is instructed by the ECM 7 to provide a torque in fill between gear shifts in order to smooth out the torque interruption that would otherwise occur. The motor function of the hydraulic pumping mechanism 25 applies an appropriate amount of torque at an appropriate time to the gearbox output shaft 9 in order to achieve this. This is very useful when an automated manual gearbox is used because during a gear change there is a short period of time when no drive can be transmitted.

As the starter-generator unit 22 has the capability to drive or be driven by the flywheel 10, it can be used to spin up or slow down the flywheel 10 to within its optimum operating range.

Advantageously, the starter function can be used to pre-charge the flywheel 10 before starting the engine 2 and pulling away from rest. Hence, as an alternative to the method of pre-charging using the engine (as described above with reference to FIG. 2), the starter-generator unit 22 is employed as follows in a flywheel charging mode.

The ECM 7 opens the clutch 6 and selects neutral in the gearbox 5. With the second clutch 11 engaged, the ECM 7 instructs the starter-generator unit 22 to crank the driveline 8 (using electrical power from the battery 23). The starter 22 keeps cranking until the flywheel 10 reaches a pre-determined speed, set by the ECM 7 and monitored by the speed sensor 17. When this point is reached, the ECM 7 instructs the starter unit 22 to cease cranking.

When the flywheel 10 has reached the required rotational speed the ECM 7 then selects an engine start and combined power mode and instructs the ECU 20 to start the engine 2, selects a forward (or reverse gear) in the gearbox 5 and engages the clutch 6. The vehicle can now move off under engine power supplemented by the flywheel power.

This procedure of pre-charging the flywheel 10 in a stationary vehicle can also be implemented using the engine's starter motor (not shown) installed in a conventional location whereby it directly cranks the engine. In this starter charge modee, the clutch 11 is closed and neutral is selected as before. The clutch 6 is closed but the engine is initially prevented from firing by inhibiting the fuel supply system. Parasitic losses can be reduced by closing all poppet valves. Further, the alternator, air conditioning and other accessories can be disabled during the flywheel charging process. When the desired flywheel speed is reached, the accessories can be enabled and the engine 2 allowed to fire.

In an accessory drive mode, if the vehicle has been stopped and the engine switched off, yet the flywheel 10 is still spinning with surplus energy (high SOC) which has been stored during the preceding drive cycle, then this energy can be used as follows. For example, in the case where an air conditioning pump is connected to the first power take-off device 21, with the clutch 6 open the second clutch 11 closed and neutral selected in the gearbox 5, the flywheel can power the vehicle's air conditioning unit its speed eventually decays to zero.

Alternatively, the surplus flywheel energy can be used in a battery charging mode to charge the battery 23 via the generator function of the starter generator unit 22. The CVT ratio can be selected (by the ECM 7) so that the alternator or air conditioning unit operate at their most efficient rates.

In instances where the vehicle is parked for long periods, say overnight, the ECM 7 can predict (with the help on an onboard navigation system for example) the respective states of charge of the flywheel 10 and battery 23 on arrival at the final destination. Thereby, usage of each of these energy storage means can be optimised for maximum fuel economy. Say, for example that the final destination is at the bottom of a hill. The ECU 7 ensures that the flywheel 10 is fully charged after the downhill deceleration to a standstill and that the battery is at a low state of charge (through controlling the charging rate of the starter generator unit 22). Then while the vehicle is parked, the stored flywheel energy is transferred to the battery 23 via the generator function of the starter-generator unit 22. During this procedure the ECU 7 ensures that the second clutch 11 is closed, the first clutch 6 is open and neutral is selected in the gearbox 5. This flywheel run-down battery charge mode of operation makes good usage of the surplus flywheel energy which would otherwise be lost through friction. Furthermore, it ensures that the battery 23 is in a good state of charge for its next usage.

Once the energy transfer is complete, the ECM 7 can select a gear other than neutral for parking, (to assist the parking brake in holding the vehicle stationary).

In another mode of operation known as burst and cruise the vehicle is driven by the flywheel 10 but when the SOC of the flywheel reaches a predefined lower limit the ECM 7 selects neutral in the gearbox 5 starts the engine 2 and operates it in an optimised fuel usage/emission state with the first and second clutches 6 and 11 both engaged so as to recharge the flywheel 10 and then, as soon as the flywheel 10 has reached a predefined high level of SOC, the ECM 7 disengages the first clutch 6, keeps the second clutch 11 engaged, shuts down the engine 2 and engages the previously engaged gear.

Therefore in summary, the invention provides a driveline for a hybrid vehicle that enables the various driveleine components to be used in an optimised fashion so as to meet a current operational need while minimising fuel usage and emissions from the engine.

In one advantageous embodiment the first clutch is a conventional clutch attached to a flywheel connected to a crankshaft of the engine 2 and the automated manual gearbox is attached directly to the engine in a known manner and uses conventional components, thereby reducing cost and design time.

In another advantageous embodiment the drivetrain includes a generator connectable with the distal end of said input shaft and a battery connected to the generator and, upon establishing a need for zero to emission cruising, a zero emission drive mode is selected in which the generator and the flywheel are used in combination to drive the input shaft. The generator using electrical power previously stored in the battery.

One advantage of the invention is that, because the flywheel is driveably attached to the input shaft of the gearbox, there is less backlash in the drive thereby improving driveline refinement and reducing the effect of impact or shock loading.

In a preferred embodiment an automatic shifting manual transmissions is used. Such transmissions are known. See for example SAE technical paper 2004-01-3363.

A vehicle fitted with this type of transmission has no clutch pedal, the clutch being engaged and disengaged automatically by an electro-hydraulic actuator. A modified gear shift lever enables a shift-by-wire operation whereby, in response to a driver input, the gears in the gearbox are selected and shifted by electro-mechanical actuators. In the preferred embodiment of this invention, the gearbox is arranged so that gear selection and shifting is under the control of an electronic control module rather than the driver.

It will however be appreciated that the invention could be used with other types of gearbox and is not limited to use with an automated manual gearbox.

The clutches used are preferably electro-hydraulically operated clutches responsive to a control signal generated by an electronic control unit which is provided on the vehicle.

The output shaft of the gearbox may be arranged to drive a front axle, a rear axle or both front and rear axles.

By applying driving torque from the prime mover and the energy storage and recovery device to the same point (i.e. the gearbox input shaft) driveline lash is minimised compared with other known hybrid vehicle architectures.

The invention also alleviates packaging constraints.

It will be appreciated by those skilled in the art that although the invention has been described by way of example with reference to one or more embodiments it is not limited to the disclosed embodiments and that one or more modifications to the disclosed embodiments or alternative embodiments could be constructed without departing from the scope of the invention as set out in the appended claims.

1. A drivetrain for a hybrid vehicle comprising a prime mover, an energy storage and recovery system and a gearbox wherein the energy storage and recovery system is a high speed flywheel, the gearbox has an input shaft and an output shaft driveably connected to the input shaft to provide a number of drive ratios and operable to provide drive to at least one road wheel, one end of the input shaft is connectable with the prime mover via a first clutch and a distal end of the input shaft is connectable with the flywheel via a second clutch.

2. A drivetrain for a hybrid vehicle as claimed in claim 1 wherein the drivetrain further comprises a continuously variable transmission located between the flywheel and the second clutch.

3. A drivetrain as claimed in claim 1 or in claim 2 wherein the drivetrain further comprises a controller to control the operation of the prime mover, the first and second clutches and the power flow to and from the flywheel.

4. A drivetrain for a hybrid vehicle as claimed in claim 3 wherein the controller is arranged to receive at least one input indicative of a driver demand and control the operation of the prime mover, the first and second clutches and the power flow to and from the flywheel based upon at least one of the current state of charge of the flywheel, the current operating state of the prime mover and a current driver demand in order to satisfy a current operating need.

5. A drivetrain for a hybrid vehicle as claimed in any preceding claim in which the gearbox is an automated manual gearbox.

6. A drivetrain as claimed in claim 5 wherein the drivetrain further comprises a hydraulic machine driveably connected to the output shaft and hydraulic accumulator connected to the hydraulic machine wherein the hydraulic machine is driven by the output shaft during normal running of the drivetrain to charge the hydraulic accumulator and the hydraulic machine is arranged to receive hydraulic fluid from the hydraulic accumulator during a gear change operation of the gearbox so as to maintain the flow of power to the at least one driven wheel during the gear change.

7. A drivetrain for a hybrid vehicle wherein the drivetrain further comprises an electric machine driveably connected to the input shaft and battery operatively connected to the electric machine wherein the electric machine is arranged to be driven by the input shaft in order to charge the battery.

8. A drivetrain as claimed in claim 7 wherein, when required, the electric machine is arranged to drive the input shaft using power stored in the battery.

9. A drivetrain as claimed in any of claims 1 to 8 wherein the first and second clutches are both closed and the prime mover and the flywheel are both used to drive the input shaft to drive the hybrid vehicle.

10. A drivetrain for a hybrid vehicle as claimed in any of claims 1 to 9 wherein the prime mover is an internal combustion engine.

11. A drivetrain as claimed in claim 10 wherein the drivetrain include a starter motor for starting the engine and the starter motor is selectively used to recharge the flywheel.

12. A hybrid vehicle having a drivetrain as claimed in any of claims 1 to 11.

13. A method of operating a hybrid vehicle in which the vehicle includes a drivetrain comprising a gearbox, a prime mover, connectable with one end of an input shaft of the gearbox via a first clutch, an energy storage and recovery device in the form of a high speed flywheel connectable with a distal end of said input shaft via a second clutch and an output shaft driveably connected to the input shaft to provide a number of drive ratios and operable to provide drive to at least one road wheel, the method comprising operating the drivetrain in one of a number of predefined operating modes in order to satisfy a current operating need, wherein the current operating need is based upon at least one of a state of charge of the flywheel, the operating state of the prime mover and a driver demand.

14. A method as claimed in claim 13 wherein the method further comprises prioritising the operating needs and selecting an operating mode to satisfy the need accorded the highest priority.

15. A drivetrain for a hybrid vehicle substantially as described herein with reference to the accompanying drawing.

16. A hybrid vehicle substantially as hereinbefore described with reference to the drawings.

17. A method of operating a hybrid vehicle substantially as hereinbefore described with reference to the drawings.
